(19) United States
(12) Patent Application Publication
(10) Pub. No.: US 2016/0018051 A1
(43) Pub. Date: Jan. 21, 2016

(54) HOLDING DEVICE

(71) Applicant: SYNCMOLD ENTERPRISE CORP., New Taipei City (TW)

(72) Inventor: Hung-Yu Lin, New Taipei City (TW)

(21) Appl. No.: 14/487,098

(22) Filed: Sep. 16, 2014

(30) Foreign Application Priority Data
Jul. 16, 2014 (TW) 103212631

(51) Int. Cl. F16M 11/06; A47F 7/00; F16M 11/18

(52) U.S. Cl. CPC F16M 11/06; F16M 11/18; A47F 7/00

(57) ABSTRACT

A holding device includes a frame, a rotating arm, a first swing arm and a second swing arm. The rotating arm is pivoted to the frame and switchable between a first position and a second position relative to the frame. The first swing arm and the second swing arm are pivoted to the rotating arm and tend to rotate in a rotating direction. When the rotating arm is in the first position with the first swing arm and the second swing arm clamping two long sides of an electronic device, the first swing arm and the second swing arm are spaced at a first distance. When the rotating arm is in the second position with the first swing arm and the second swing arm clamping two short sides of the electronic device, the first swing arm and the second swing arm are spaced at a second distance.

### BACKGROUND OF THE INVENTION

1. Field of the Invention

The present invention relates to a holding device, and more particularly, to a holding device capable of generating different holding distances by utilizing rotating mechanism.

2. Description of the Prior Art

Please refer to FIG. 1. FIG. 1 is a diagram of an electronic device holder 9 in the prior art. The electronic device holder 9 includes a rotating unit 91 and a holding unit 92. The holding unit 92 is installed on the rotating unit 91. The holding unit 92 includes a fixing member 921, a secure clamping arm 922 and a movable clamping arm 923. The fixing member 921 is for supporting an electronic device, not shown in figures. The secure clamping arm 922 is fixed on the fixing member 921, and the movable clamping arm 923 is movably disposed on the fixing member 921. The electronic device holder 9 further utilizes a spring 93 for driving the movable clamping arm 923 to recover relative to the secure clamping arm 922. Accordingly, the secure clamping arm 922 and movable clamping arm 923 can hold two opposite sides of the electronic device cooperatively, so as to fix the electronic device on the fixing member 921.

However, since the electronic device holder 9 utilizes the spring 93 for driving the movable clamping arm 923, the spring 93 is oriented identically to a moving direction of the movable clamping arm 923. In such manner, the electronic device holder 9 needs an enough mechanical space to accommodate the spring 93 in the moving direction of the movable clamping arm 923, leading to a dimensional constraint of the electronic device holder 9 in the moving direction of the movable clamping arm 923. Thus, it disadvantages the electronic device holder 9 for containing.

### SUMMARY OF THE INVENTION

Therefore, the present invention provides a holding device capable of generating different holding distances by utilizing rotating mechanism for solving the above drawbacks.

According to the claimed invention, a holding device for holding an electronic device with two long sides and two short sides includes a frame, a rotating arm, a first holding mechanism and a second holding mechanism. The rotating arm is pivoted to the frame and capable of switching between a first position and a second position relative to the frame. The rotating arm has a first end and a second end opposite to the first end. The first holding mechanism includes a first swing arm pivoted to the first end of the rotating arm, and the first swing arm tends to rotate in a rotating direction. The second holding mechanism includes a second swing arm pivoted to the second end of the rotating arm, and the second swing arm tends to rotate in the rotating direction. When the rotating arm is in the first position and when the first swing arm and the second swing arm respectively hold the two long sides of the electronic device, the first swing arm and the second swing arm are spaced at a first distance. When the rotating arm is in the second position and when the first swing arm and the second swing arm respectively hold the two short sides of the electronic device, the first swing arm and the second swing arm are spaced at a second distance.

According to the claimed invention, the first holding mechanism further includes a first resilient member connecting the first end with the first swing arm and capable of driving the first swing arm to rotate in the rotating direction, and the second holding mechanism further includes a second resilient member connecting the second end with the second swing arm and capable of driving the second swing arm to rotate in the rotating direction.

According to the claimed invention, the first resilient member is a torsion spring. The rotating arm includes a first abutting portion for abutting against an end of the first resilient member, and the first swing arm has a first stopping portion for stopping another end of the first resilient member.

According to the claimed invention, a first C-shaped plate is formed on the rotating arm and located in a position near the first end. The first resilient member sleeves the first C-shaped plate, and the rotating arm further includes a first back cover installed on the rotating arm.

According to the claimed invention, the second resilient member is a torsion spring. The rotating arm further includes a second abutting portion for abutting against an end of the second resilient member, and the second swing arm has a second stopping portion for stopping the other end of the second resilient member.

According to the claimed invention, a second C-shaped plate is formed on the rotating arm and located in a position near the second end. The second resilient member sleeves the second C-shaped plate and the rotating arm further includes a second back cover installed on the rotating arm.

According to the claimed invention, the first holding mechanism further includes a first clamping structure disposed on the first swing arm. The first clamping structure and the first swing arm cooperatively define a first clamping notch. The second holding mechanism further includes a second clamping structure disposed on the second swing arm. The second clamping structure and the second swing arm cooperatively define a second clamping notch. The first clamping notch and the second clamping notch cooperatively accommodate the two long sides or the two short sides of the electronic device.

According to the claimed invention, the first swing arm has a first engaging structure, and the second swing arm has a second engaging structure. The rotating arm includes a first protrusion and a second protrusion. The first protrusion is corresponding to the first engaging structure for abutting against the first engaging structure. The second protrusion is corresponding to the second engaging structure for abutting against the second engaging structure. When the first protrusion abuts against the first engaging structure and the second protrusion abuts against the second engaging structure, the first swing arm is substantially parallel to the second swing arm.

According to the claimed invention, the first swing arm has a third engaging structure, and the second swing arm has a fourth engaging structure. The rotating arm includes a third protrusion and a fourth protrusion. The third protrusion is corresponding to the third engaging structure for abutting against the third engaging structure. The fourth protrusion is corresponding to the forth engaging structure for abutting against the forth engaging structure. When the third protrusion abuts against the third engaging structure and the forth protrusion abuts against the fourth engaging structure, the first swing arm is substantially parallel to the second swing arm.

According to the claimed invention, a first accommodation groove and a second accommodation groove are formed on the first swing arm. A third accommodation groove and a fourth accommodation groove are formed on the second swing arm. The first accommodation groove is adjacent to the first engaging structure, and the second accommodation groove is adjacent to the third engaging structure. The third accommodation groove is adjacent to the second engaging structure, and the fourth accommodation groove is adjacent to the fourth engaging structure.

According to the claimed invention, the rotating arm is capable of rotating to a third position relative to the frame. The first holding mechanism further includes a first hook connected to the first swing arm. The second holding mechanism further includes a second hook connected to the second swing arm. The first hook hooks the second hook when the rotating arm is in the third position, such that the first swing arm and the second swing arm substantially coincide with the rotating arm.

According to the claimed invention, the holding device further includes a driving member disposed between the frame and the rotating arm for driving the rotating arm to switch between the first position and the second position.

According to the claimed invention, the frame includes a frame body, a pivot shaft, and a connecting assembly. The pivot shaft is installed on the frame body. The connecting assembly includes a first casing, a second casing and a third casing. The first casing is pivoted to the pivot shaft. The second casing is installed on the first casing for being pivoted to the rotating arm. The third casing is disposed on the second casing for constraining the rotating arm cooperatively with the second casing.

According to the claimed invention, the second casing has at least one stopping protrusion. The rotating arm has at least one stopping rib. At least one engagement slot is formed on the at least one stopping rib. The at least one stopping protrusion engages with the at least one engagement slot when the rotating arm rotates to the first position relative to the second casing.

According to the claimed invention, the holding device further includes a driving member disposed between the second casing and the rotating arm for driving the rotating arm to rotate between the first position and the second position.

According to the claimed invention, the driving member is a torsion spring. The rotating arm has a first abutting rib for abutting against an end of the driving member. The second casing has a second abutting rib for abutting against another end of the driving member.

In summary, the holding device of the present invention utilizes the rotating mechanism that the rotating arm is pivoted to the frame for holding the electronic device with two long sides or two short sides or for holding the two electronic devices with different sizes. The distance between the two ends of the rotating arm varies when the rotating arm rotates relative to the frame. In other words, the holding device of the present invention utilizes the rotating mechanism of the rotating arm for varying the distance between the two ends of the rotating arm. As a result, the rotating arm can be contained on the frame for saving storage space of the holding device when the holding device of the present invention is not in use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a drawing of an electronic device holder in prior art.

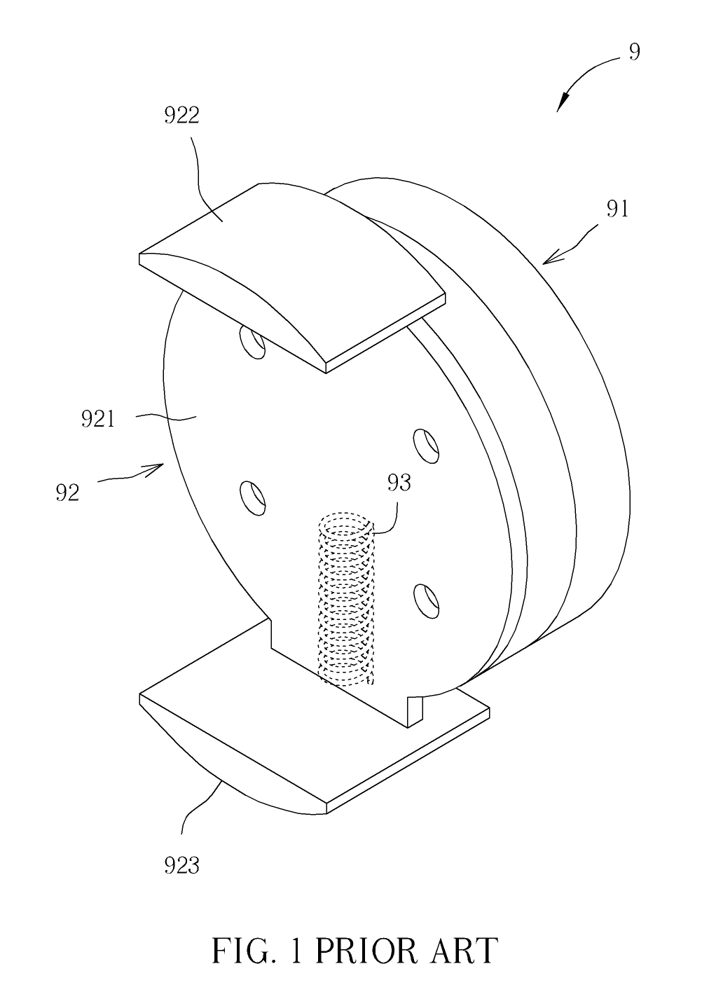

FIG. 2 is a drawing of a holding device according to an embodiment of the present invention.

FIG. 3 is an exploded drawing of the holding device according to the embodiment of the present invention.

FIG. 4 is an exploded drawing of the holding device from another view according to the embodiment of the present invention.

FIG. 5 is a drawing of the holding device in a collapse situation according to the embodiment of the present invention.

FIG. 6 is a sectional drawing of the holding device in the containing situation according to the embodiment of the present invention.

FIG. 7 is a drawing of the holding device according to a first holding position in the embodiment of the present invention.

FIG. 8 is a sectional drawing of the holding device in the first holding position according to the embodiment of the present invention.

FIG. 9 is a drawing of the holding device in a second holding position according to the embodiment of the present invention.

FIG. 10 is a sectional drawing of the holding device in the second holding position according to the embodiment of the present invention.

### DETAILED DESCRIPTION

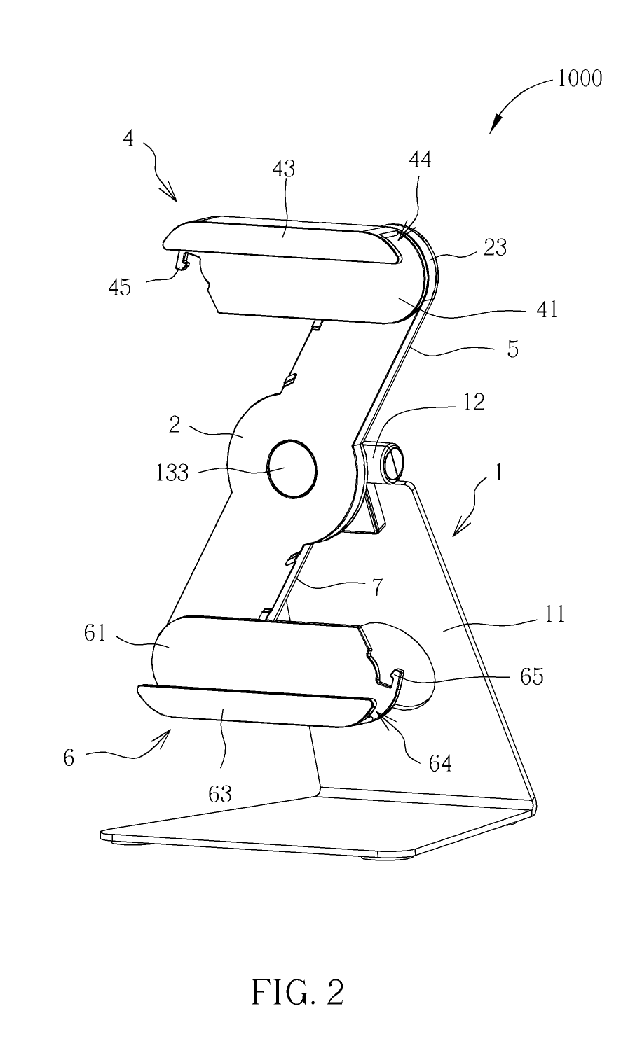

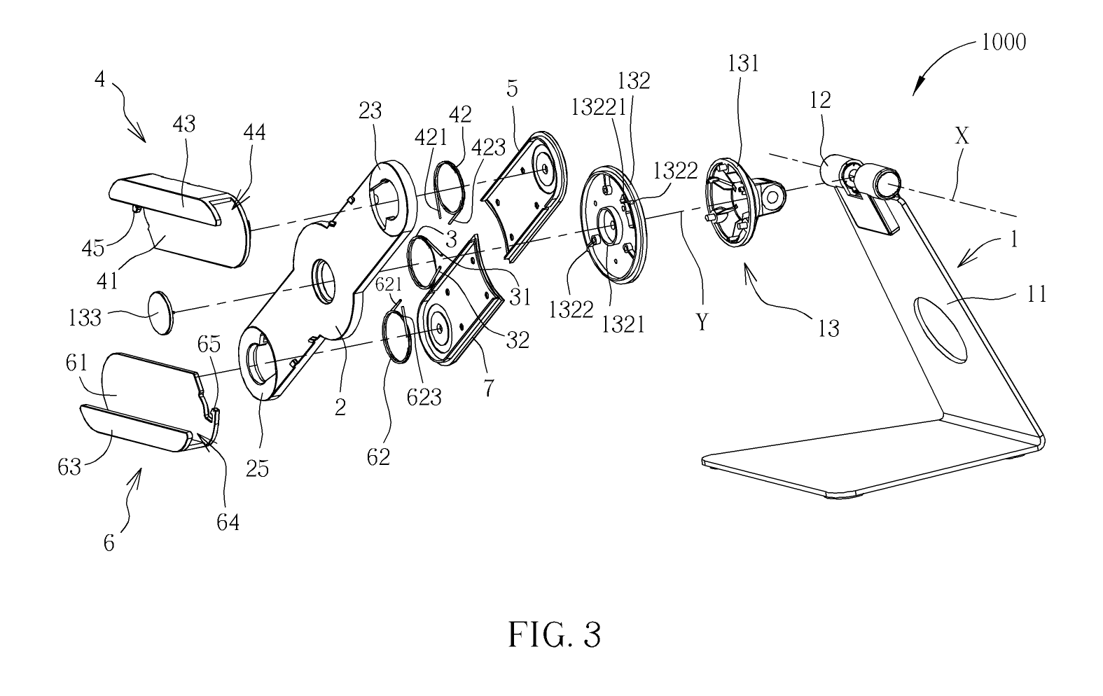

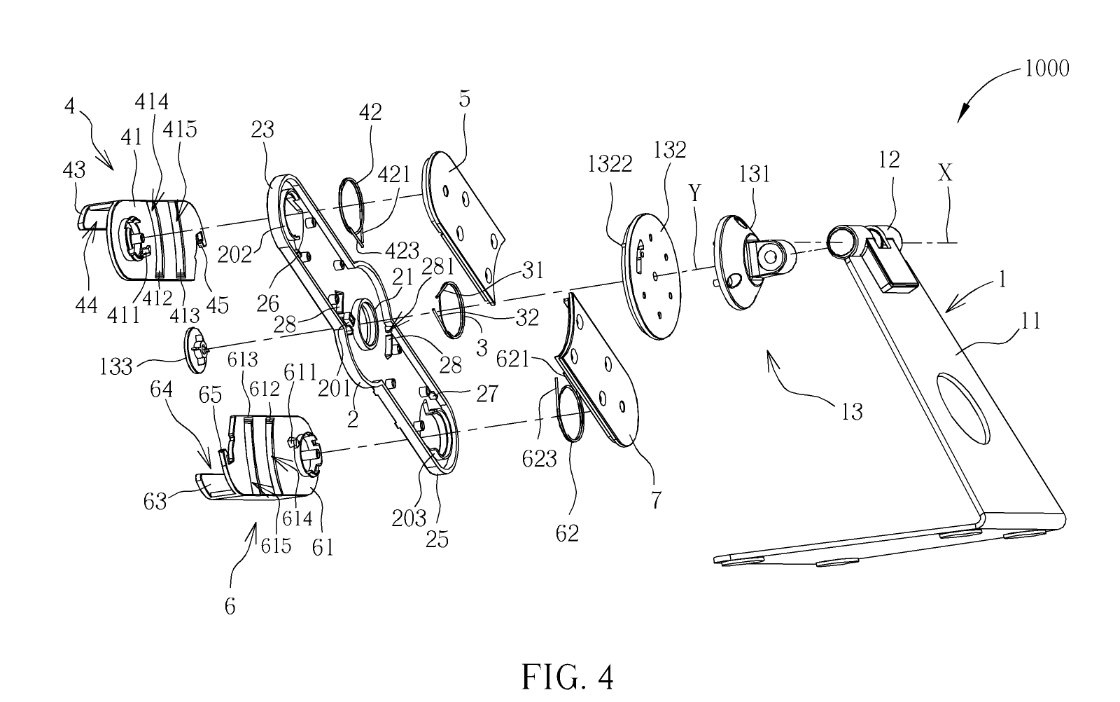

Please refer to FIG. 2 to FIG. 4. The holding device 1000 includes a frame 1, a rotating arm 2, a driving member 3, a first holding mechanism 4 and a second holding mechanism 5. The rotating arm 2 is pivoted to the frame 1. The driving member 3 drives the rotating arm 2 to rotate, relative to the frame 1, to different positions. The first holding mechanism 4 and the second holding mechanism 5 are installed on two ends of rotating arm 2 respectively.

The frame 1 includes a frame body 11, a pivot shaft 12 and a connecting assembly 13. In this embodiment, the frame body 11 is a bending-shaped plate for being placed on a support surface, such as a desktop, and thus the holding device 1000 stands on the support surface. The pivot shaft 12 is installed on an end of the frame body 11 far from the support surface. The connecting assembly 13 is used for connecting the pivot shaft 12 with rotating arm 2, so that the rotating arm 2 rotates relative to an axis X of the pivot shaft 12.

Furthermore, the connecting assembly 13 of the frame 1 includes a first casing 131, a second casing 132 and a third casing 133. The first casing 131 is pivoted to the pivot shaft 12. The second casing 132 is installed on the first casing 131 and abuts against a side of the rotating arm 2. The third casing 133 is installed on the second casing 132 and abuts against another side of the rotating arm 2. Accordingly, the rotating arm 2 can be constrained by the second casing 132 and the third casing 133.

In this embodiment, the second casing 132 has a first rib ring 1321 disposed on a side thereof abutting against the rotating arm 2. The rotating arm 2 has a second rib ring 21 located in a position corresponding to the first rib ring 1321. The second rib ring 21 rotatably engages with the first rib ring 1321, so that the rotating arm 2 is pivoted to the second casing 132. In such a manner, the rotating arm 2 can rotate relative to a ring axis Y of the first rib ring 1321. In this embodiment, the ring axis Y is substantially perpendicular to the axis X, but it is not limited to this embodiment.

In this embodiment, the driving member 3 is disposed between the second casing 132 and the rotating arm 2. Furthermore, the driving member 3 can be a torsion spring with an abutting end 31 and a free end 32. The rotating arm 2 has a first abutting rib 201, and the second casing 132 has a second abutting rib 1321. The abutting end 31 and the free end 32 of the driving member 3 abut the second abutting rib 1321 of the second casing 132 and the first abutting rib 201 of the rotating arm 2, respectively. As a result, when the rotating arm 2 rotates relative to the second casing 132 of the frame 1, the first abutting rib 201 can rotate with the rotating arm 2 for activating the free end 32. Accordingly, the driving member 3 stores an elastic potential energy due to deformation. When the rotating arm 2 is released, the elastic potential energy is released to generate a resilient force for recovering the rotating arm 2.

As shown in FIG. 2 to FIG. 4, the first holding mechanism 4 is installed on a first end 23 of the rotating arm 2 and includes a first swing arm 41 and a first resilient member 42. The first swing arm 41 is pivoted to the first end 23 of the rotating arm 2. The first resilient member 42 connects the first end 23 of the rotating arm 2 with the first swing arm 41 and is capable of driving the first swing arm 41 to rotate in a rotating direction along which the first swing arm 41 coincides with the rotating arm 2. Furthermore, the holding device 1000 further includes a first back cover 5 installed on the rotating arm 2. The first back cover 5 and the rotating arm 2 jointly receive the first resilient member 42, so as to prevent accidental damage of the first resilient member 42 caused by collision. In this embodiment, the first resilient member 42 is a torsion spring. Additionally, the first holding mechanism 4 further includes a first clamping structure 43 disposed on the first swing arm 41. The first clamping structure 43 and the first swing arm 41 cooperatively define a first clamping notch 44.

As shown in FIG. 2 to FIG. 4, the holding device 1000 further includes a second holding mechanism 6 installed on a second end 25 opposite to the first end 23 of the rotating arm 2. The second holding mechanism 6 includes a second swing arm 61 and a second resilient member 62. The second swing arm 61 is pivoted to the second end 25 of the rotating arm 2. The second resilient member 62 connects the second end 25 of the rotating arm 2 with the second swing arm 61 and is capable of driving the second swing arm 61 to rotate in the rotating direction along which the second swing arm 61 coincides with the rotating arm 2. Furthermore, the holding device 1000 further includes a second back cover 7 installed on the rotating arm 2. The second back cover 7 and the rotating arm 2 jointly receive the second resilient member 62. In this embodiment, the resilient member 62 is a torsion spring. Additionally, the second holding mechanism 6 further includes a second clamping structure 63 disposed on the second swing arm 61. The second clamping structure 63 and the second swing arm 61 cooperatively define a second clamping notch 64.

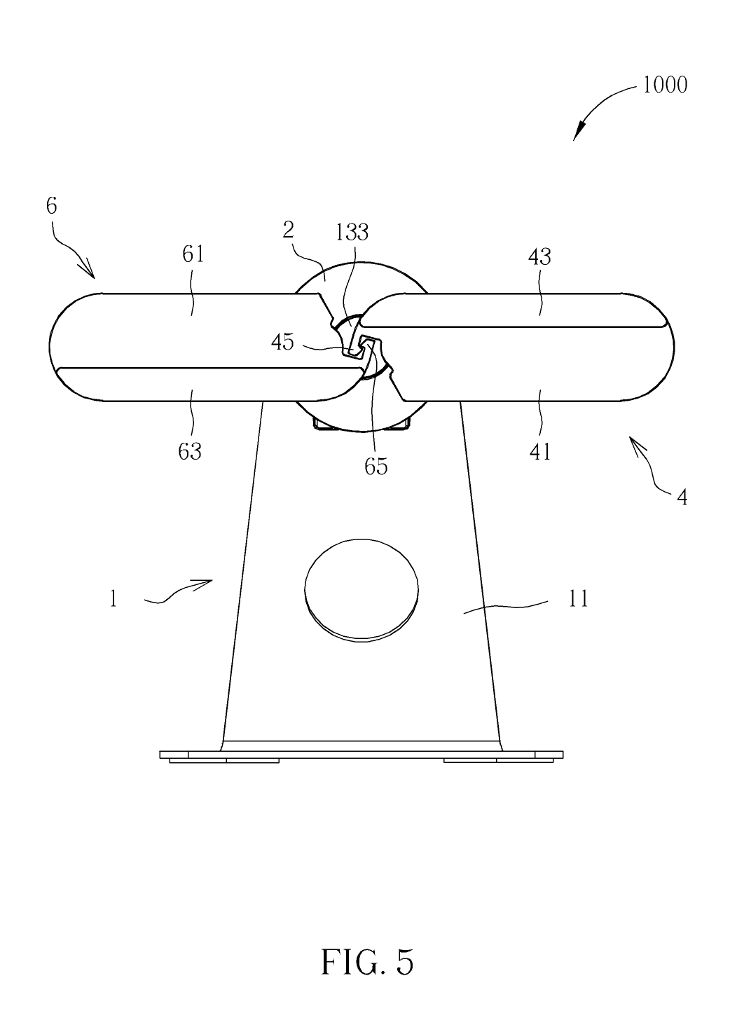

Please further refer to FIG. 5. The first holding mechanism 4 further includes a first hook 45 connected to the first swing arm 41. The second holding mechanism 6 further includes a second hook 65 connected to the second swing arm 61. When the driving member 3 drives the rotating arm 2 to rotate from a first position as shown in FIG. 2 to a coincided position as shown in FIG. 5, the first hook 45 hooks the second hook 65, so as to fix the first swing arm 41 and the second swing arm 61 in the coincided position. At the same time, the first swing arm 41 and the second swing arm 61 substantially coincide with the rotating arm 2.

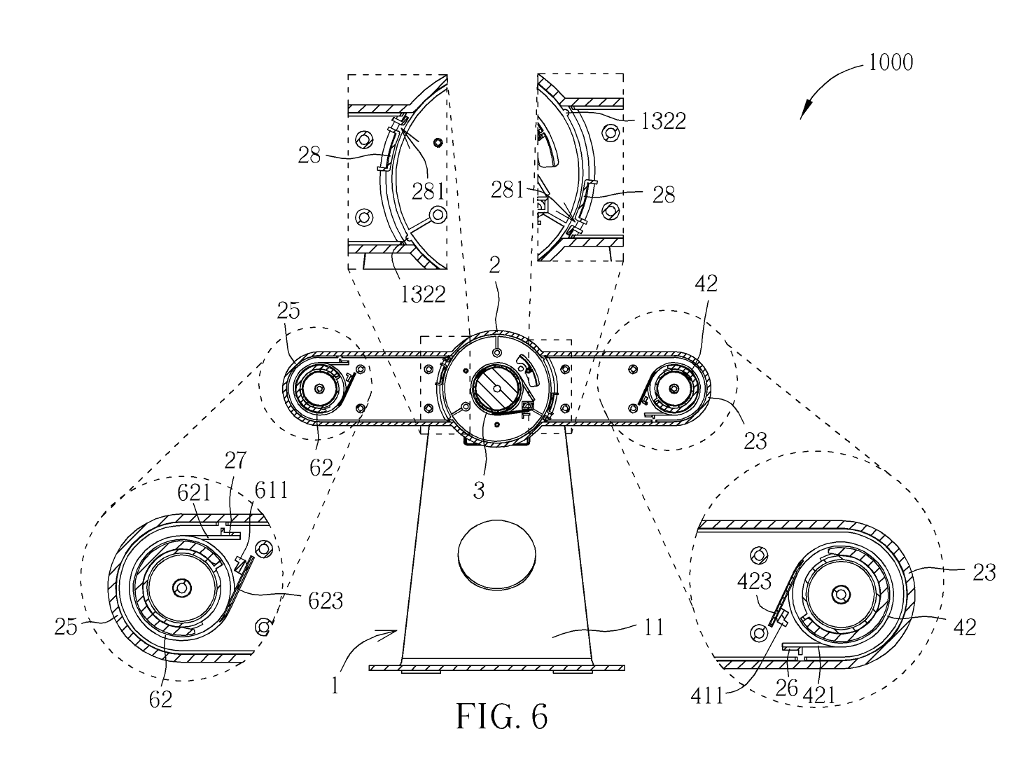

Please further refer to FIG. 6 to FIG. 8. A first C-shaped plate 202 and a first abutting portion 26 are formed on the rotating arm 2 and located near the first end 23, and the first swing arm 41 has a first stopping portion 411. The first resilient member 42 sleeves the first C-shaped plate 202. An abutting end 421 and a release end 423 of the first resilient member 42 abut against the first abutting portion 26 and the first stopping portion 411, respectively. Similarly, a second C-shaped plate 203 and a second abutting portion 27 are formed on the rotating arm 2 and located near the second end 25. The second swing arm 61 further has a second stopping portion 611. The second resilient member 62 sleeves the second C-shaped plate 203. A fixing end 621 and a free end 623 of the second resilient member 62 abut against the second abutting portion 27 and the second stopping portion 611, respectively.

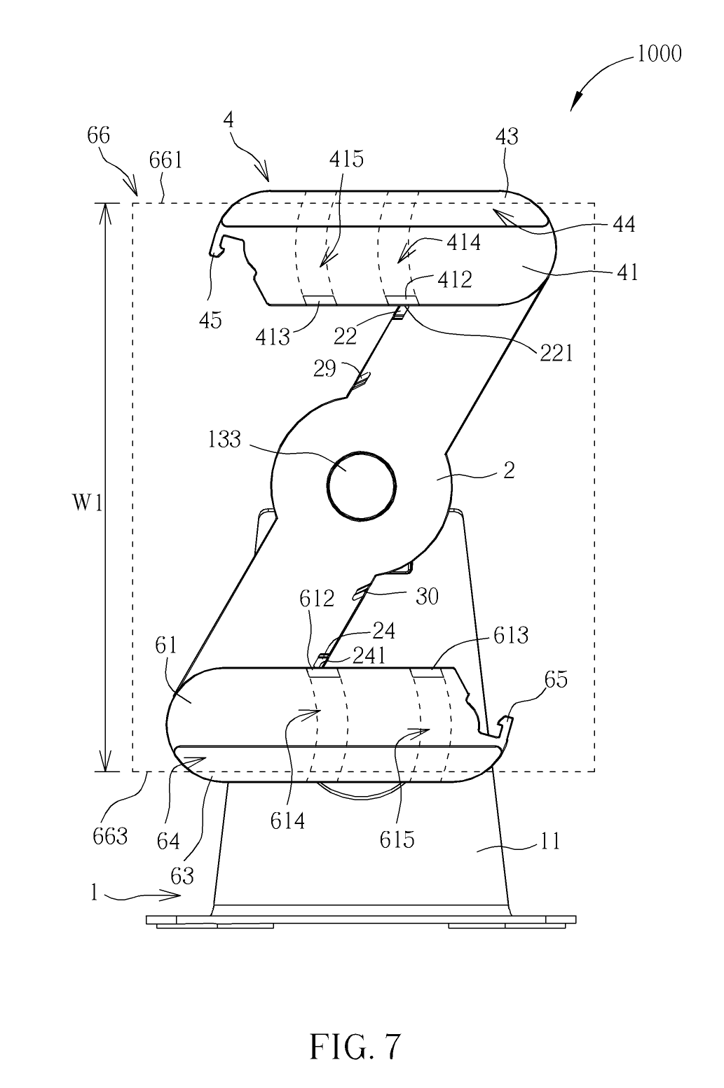

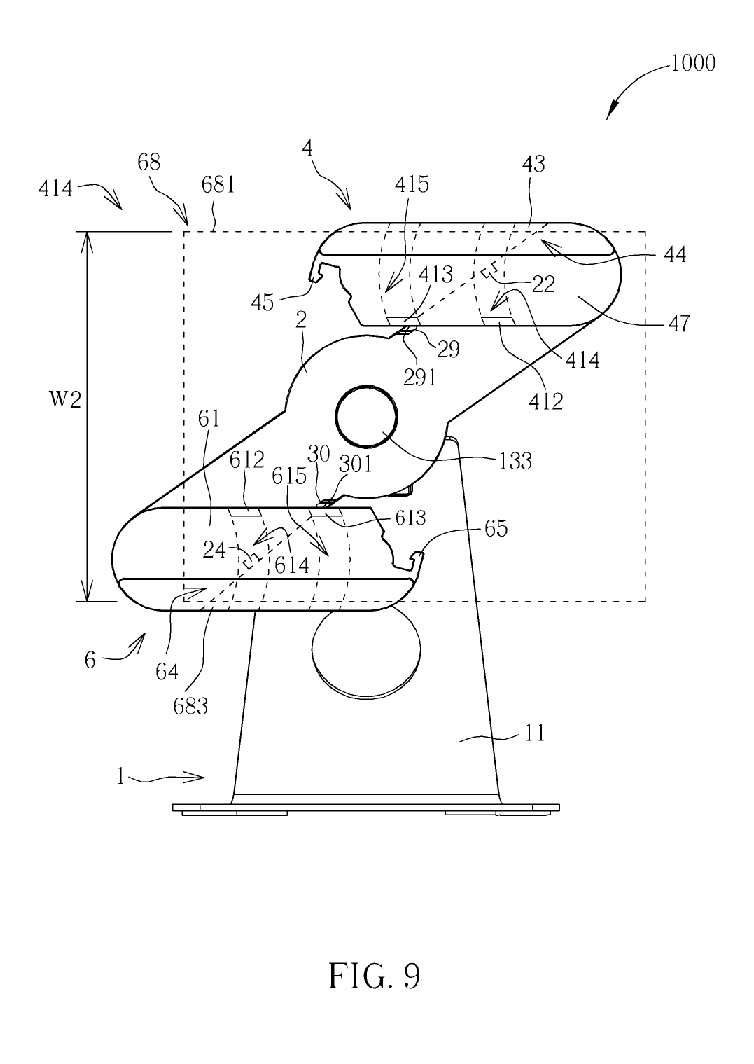

Detailed introduction of an operating principle between a first position (as shown in FIG. 7) and a second position (as shown in FIG. 9), according to the embodiment is described as follows. When the driving member 3 drives the rotating arm 2 to rotate to the first position, a distance between the first swing arm 41 of the first holding mechanism 4 and the second swing arm 61 of the second holding mechanism 6 in the gravity direction, namely, perpendicular to the support surface, is equal to a width W1 of a first electronic device 66. At the same time, the first electronic device 66 can be disposed on the rotating arm 2. The first resilient member 42 drives the first swing arm 41 to rotate toward the rotating arm 2, such that the first clamping notch 44 defined by the first swing arm 41 and the first clamping structure 43 holds a first side 661 of the first electronic device 66. The second resilient member 62 drives the second swing arm 61 to rotate toward the second rotating arm 2, such that the second clamping notch 64 defined by the second swing arm 61 and the second clamping structure 63 holds a second side 633 opposite to the first side 661 of the first electronic device 66. Accordingly, the first electronic device 66 can be firmly held.

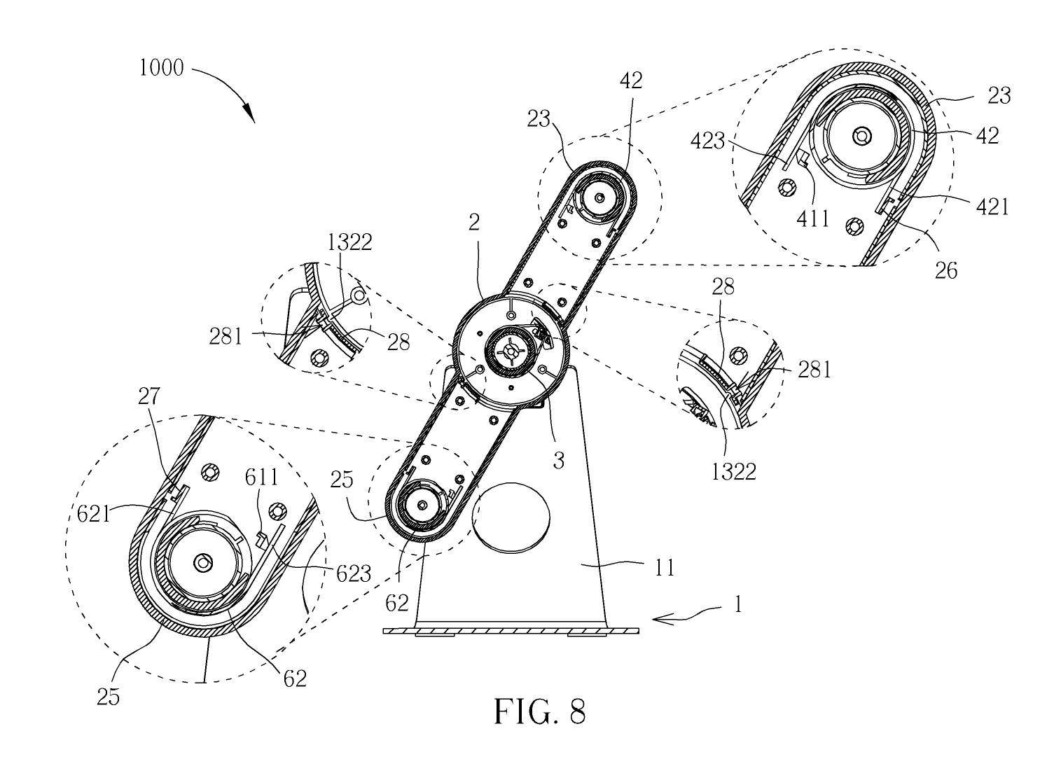

It should be noticed that the second casing 132 of the connecting assembly 13 has two stopping protrusions 1322. The rotating arm 2 has two corresponding stopping ribs 28. An engagement slot 281 is formed on each of the stopping ribs 28. When the rotating arm 2 rotates relative to the second casing 132 to the first position, each of the stopping protrusions 1322 partly engages with the engagement slots 281, as shown in FIG. 8, so that the rotating arm 2 is positioned in the first position. Those amounts and configuration of the stopping protrusion 1322 and engagement slot 281 are not limited to those illustrated in figures in this embodiment. Furthermore, an enough external force can make the stopping protrusion 1322 depart from the engagement slot 281 so as to proceed to another position, such as the second position.

In this embodiment, the first swing arm 41 can have a first engaging structure 412. The rotating arm 2 can include a first protrusion 22 corresponding to the first engaging structure 412. In practical application, the first protrusion 22 and the first engaging structure 412 can be strip-shaped. As shown in FIG. 7, the first swing arm 41 is parallel to the first side 661 of the first electronic device 66 when the first swing arm 41 rotates relative to the rotating arm 2 to a position that the first protrusion 22 abuts against the first engagement structure 412.

Similarly, the second swing arm 61 can have a second engaging structure 612. The rotating arm 2 can further include a second protrusion 24 corresponding to the second engaging structure 612. Principles of the second engaging structure 612 and the second protrusion 24 are identical to those of the first engaging structure 412 and the first protrusion 22, and descriptions are omitted herein for simplicity.

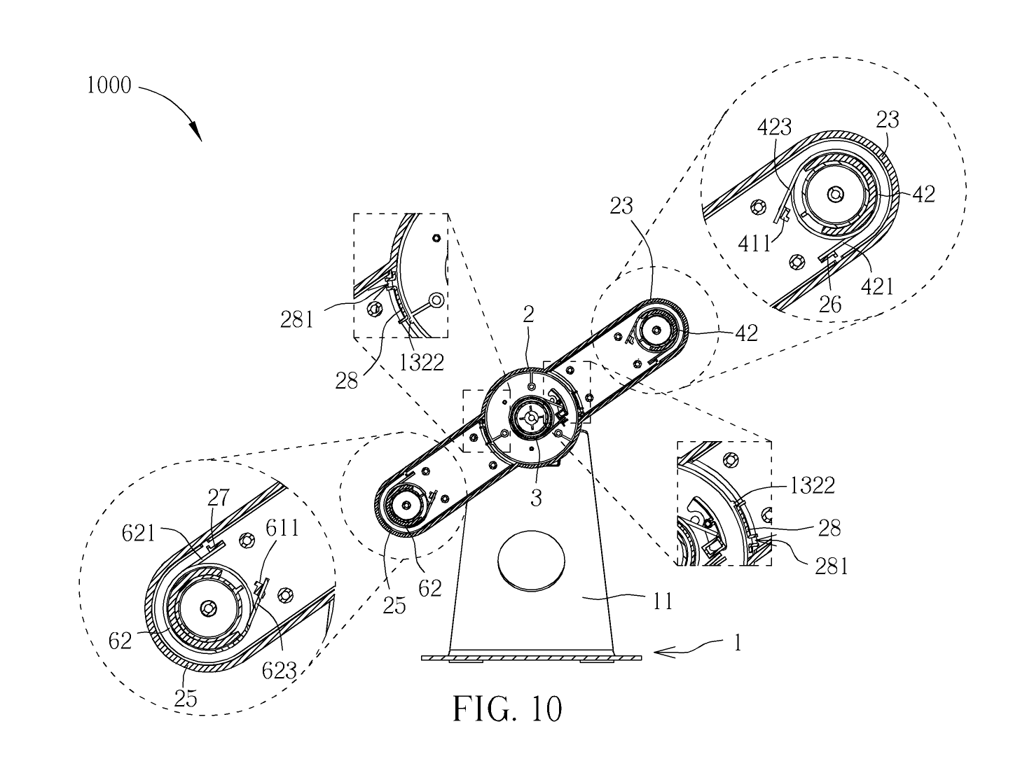

Please refer to FIG. 7 to FIG. 10. The driving member 3 can further drive the rotating arm 2 to rotate from the first position to the second position. At the same time, the distance between the first swing arm 41 of the first holding mechanism 4 and the second swing arm 61 of the second holding mechanism 6 in the gravity direction is equal to a width W2 of a second electronic device 68. The width W2 is different from the width W1. Therefore, the second electronic device 68 can be disposed on the rotating arm 2 when the driving member 3 drives the rotating arm 2 to rotate to the second position. At the same time, the first resilient member 42 drives the first swing arm 41 to rotate toward the rotating arm 2, such that the first clamping notch 44 holds a first edge 681 of the second electronic device 68. The second resilient member 62 drives the second swing arm 61 to rotate toward the rotating arm 2, such that the second clamping notch 64 holds a second edge 683 opposite to the first edge 681 of the second electronic device 68.

In this embodiment, the first swing arm 41 can have a third engaging structure 413. The rotating arm 2 can include a third protrusion 29 corresponding to the third engaging structure 413. Furthermore, the second swing arm 61 can have a fourth engaging structure 613. The rotating arm 2 can further include a fourth protrusion 30 corresponding to the fourth engaging structure 613. Principles thereof are identical to those above. Thus, the first swing arm 41 is substantially parallel to the second swing arm 61 when the third protrusion 29 abuts against the third engaging structure 413 and when the fourth protrusion 30 abuts against the fourth engaging structure 613.

It should be noticed that a first accommodation groove 414 and a second accommodation groove 415 are formed on the first swing arm 41, and a third accommodation groove 614 and a fourth accommodation groove 615 are formed on the second swing arm 61, as shown in FIG. 7 and FIG. 9. The first accommodation groove 414 is adjacent to the first engaging structure 412. The second accommodation groove 415 is adjacent to the third engaging structure 413. The third accommodation groove 614 is adjacent to the second engaging structure 612. The fourth accommodation groove 615 is adjacent to the fourth engaging structure 613. In this embodiment, the first accommodation groove 414, the second accommodation groove 415, the third accommodation groove 614 and the fourth accommodation groove 615 are arc-shaped.

During the process that the first swing arm 41 rotates from the first position to the second position, the first protrusion 22 can cross the first engaging structure 412 for entering the first accommodation groove 414 due to deformation caused by an external force applied on the first swing arm 41. At the same time, the first protrusion 22 can slide inside the first accommodation groove 414, so that the first swing arm 41 smoothly rotates from the first position to the second position. Furthermore, during the process that the first swing arm 41 rotates from the second position to the coincided position (as shown in FIG. 5), the first protrusion 22 continues to slide inside the first accommodation groove 414, and the third protrusion 29 crosses the third engaging structure 413 for entering the second accommodation groove 415. At the same time, the third protrusion 29 can slide inside the second accommodation groove 415. In such a manner, the first swing arm 41 can smoothly rotate from the second position to the coincided position.

It should be noticed that the electronic device held by the holding device 1000 of the present invention is not limited to those illustrated in figures in this embodiment. For example, the holding device 1000 of the present invention can not only hold the electronic devices with different dimensions, e.g. the first electronic device 66 or the second electronic device 68, but also hold an electronic device with two long sides and two short sides, namely, for switching between the portrait and landscape modes.

In contrast to the prior, the holding device of the present invention utilizes the rotating mechanism that rotating arm is pivoted to the frame for holding two sides of an electronic device with two long sides or two short sides or holding two electronic devices with different sizes. The distance between the two ends of the rotating arm varies when the rotating arm rotates relative to the frame. In other words, the holding device of the present invention utilizes the rotating mechanism of rotating arm for varying the distance between the two ends of the rotating arm. As a result, the holding device of the present invention can rotate the rotating arm to be contained on the frame for saving storage space of the holding device when the holding device of the present invention is not in use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A holding device for holding an electronic device with two long sides and two short sides comprising:
a frame;
a rotating arm pivoted to the frame and capable of switching between a first position and a second position relative to the frame, the rotating arm having a first end and a second end opposite to the first end;
a first holding mechanism comprising a first swing arm pivoted to the first end of the rotating arm, the first swing arm tending to rotate in a rotating direction;
a second holding mechanism comprising a second swing arm pivoted to the second end of the rotating arm, the second swing arm tending to rotate in the rotating direction; and
wherein when the rotating arm is in the first position and when the first swing arm and the second swing arm respectively hold the two long sides of the electronic device, the first swing arm and the second swing arm are spaced at a first distance;
wherein when the rotating arm is in the second position and when the first swing arm and the second swing arm respectively hold the two short sides of the electronic device, the first swing arm and the second swing arm are spaced at a second distance.

2. The holding device of claim 1, wherein the first holding mechanism further comprises a first resilient member connecting the first end with the first swing arm and capable of driving the first swing arm to rotate in the rotating direction, and the second holding mechanism further comprises a second resilient member connecting the second end with the second swing arm and capable of driving the second swing arm to rotate in the rotating direction.

3. The holding device of claim 2, wherein the first resilient member is a torsion spring, the rotating arm comprises a first abutting portion for abutting against an end of the first resilient member, and the first swing arm has a first stopping portion for stopping another end of the first resilient member.

4. The holding device of claim 3, wherein a first C-shaped plate is formed on the rotating arm and located in a position near the first end, the first resilient member sleeves the first C-shaped plate, and the rotating arm further comprises a first back cover installed on the rotating arm.

5. The holding device of claim 4, wherein the second resilient member is a torsion spring, the rotating arm further comprises a second abutting portion for abutting against an end of the second resilient member, and the second swing arm having a second stopping portion for stopping the other end of the second resilient member.

6. The holding device of claim 5, wherein a second C-shaped plate is formed on the rotating arm and located in a position near the second end, the second resilient member sleeves the second C-shaped plate and the rotating arm further comprises a second back cover installed on the rotating arm.

7. The holding device of claim 1, wherein the first holding mechanism further comprises a first clamping structure disposed on the first swing arm, the first clamping structure and the first swing arm cooperatively define a first clamping notch, the second holding mechanism further comprises a second clamping structure disposed on the second swing arm, the second clamping structure and the second swing arm cooperatively define a second clamping notch, and the first clamping notch and the second clamping notch cooperatively accommodate the two long sides or the two short sides of the electronic device.

8. The holding device of claim 1, wherein the first swing arm has a first engaging structure, the second swing arm has a second engaging structure, and the rotating arm comprises:
a first protrusion corresponding to the first engaging structure for abutting against the first engaging structure; and
a second protrusion corresponding to the second engaging structure for abutting against the second engaging structure,
when the first protrusion abuts against the first engaging structure and the second protrusion abuts against the second engaging structure, the first swing arm is substantially parallel to the second swing arm.

9. The holding device of claim 8, wherein the first swing arm has a third engaging structure, the second swing arm has a fourth engaging structure, and the rotating arm comprises:
a third protrusion corresponding to the third engaging structure for abutting against the third engaging structure; and
a forth protrusion corresponding to the forth engaging structure for abutting against the forth engaging structure,
when the third protrusion abuts against the third engaging structure and the forth protrusion abuts against the fourth engaging structure, the first swing arm is substantially parallel to the second swing arm.

10. The holding device of claim 9, wherein a first accommodation groove and a second accommodation groove are formed on the first swing arm, a third accommodation groove and a fourth accommodation groove are formed on the second swing arm, the first accommodation groove is adjacent to the first engaging structure, the second accommodation groove is adjacent to the third engaging structure, the third accommodation groove is adjacent to the second engaging structure, and the fourth accommodation groove is adjacent to the fourth engaging structure.

11. The holding device of claim 1, wherein the rotating arm is capable of rotating to a third position relative to the frame, the first holding mechanism further comprises a first hook connected to the first swing arm, the second holding mechanism further comprises a second hook connected to the second swing arm, the first hook hooks the second hook when the rotating arm is in the third position, such that the first swing arm and the second swing arm substantially coincide with the rotating arm.

12. The holding device of claim 1, further comprising a driving member disposed between the frame and the rotating arm for driving the rotating arm to switch between the first position and the second position.

13. The holding device of claim 1, wherein the frame comprises:
a frame body;
a pivot shaft installed on the frame body; and
a connecting assembly, comprising:
a first casing pivoted to the pivot shaft;
a second casing installed on the first casing for being pivoted to the rotating arm; and
a third casing disposed on the second casing for constraining the rotating arm cooperatively with the second casing.

14. The holding device of claim 13, wherein the second casing has at least one stopping protrusion, the rotating arm has at least one stopping rib, at least one engagement slot is formed on the at least one stopping rib, the at least one stopping protrusion engages with the at least one engagement slot when the rotating arm rotates to the first position relative to the second casing.

15. The holding device of claim 13, further comprising a driving member disposed between the second casing and the rotating arm for driving the rotating arm to rotate between the first position and the second position.

16. The holding device of claim 15, wherein the driving member is a torsion spring, the rotating arm has a first abutting rib for abutting against an end of the driving member, and the second casing has a second abutting rib for abutting against another end of the driving member.
